(19) United States
(12) Patent Application Publication
(10) Pub. No.: US 2005/0039740 A1
(43) Pub. Date: Feb. 24, 2005

(54) Method and system for the controlled admixing of a gas or a gas mixture to a gas (mixture) flow

(75) Inventors: Markus Fritz, Moedling (AT); Christian Krebs, Voesendorf (AT); Rainer Muellner, Wiender Neudorf (AT); Christian Romako, Loosdorf (AT)

Correspondence Address: CROWELL & MORING LLP;INTELLECTUAL PROPERTY GROUP, P.O. BOX 14300, WASHINGTON, DC, 20044-4300, US

(73) Assignee: INO Therapeutics GmbH

(21) Appl. No.: 10/844,574

(22) Filed: May 13, 2004

(30) Foreign Application Priority Data
May 13, 2003 (DE) 103 214 48.8

(51) Int. Cl. A62B 7/00

(52) U.S. Cl. 128/200.24

(57) ABSTRACT

A method and system for the controlled admixing of at least one gas or gas mixture to a gas (mixture) flow, so that, after the admixing to the gas (mixture) flow, the gas or gas mixture has a preadjusted and/or preadjustable concentration in this gas (mixture) flow by use of a pressure controller.

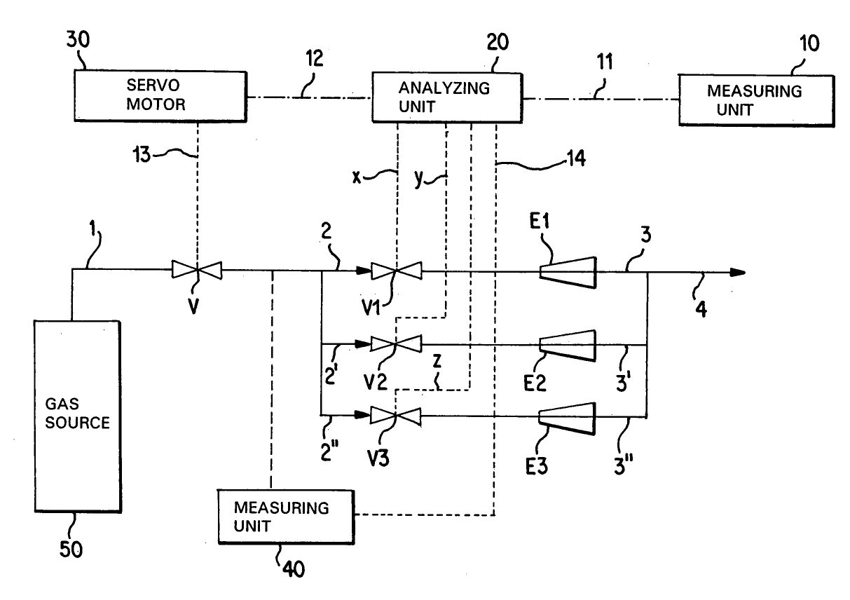

### BACKGROUND AND SUMMARY OF THE INVENTION

This application claims the priority of German Patent No. 103 214 48.8, filed 13 May 2003, the disclosure of which is expressly incorporated by reference herein.

The invention relates to a method for the controlled admixing of at least one gas or gas mixture to a gas (mixture) flow, so that, after the admixing to the gas (mixture) flow, the gas or gas mixture has a preadjusted and/or preadjustable concentration in this gas (mixture) flow, wherein
a) the volume flow rate and/or pressure of the gas (mixture) flow is determined,
b) the actual value of the volume flow rate and/or of the pressure of the gas or gas mixture to be admixed is determined,
c) as a function of the determined volume flow rate and/or pressure of the gas (mixture) flow, the desired value of the volume flow rate and/or of the pressure of the gas or gas mixture to be admixed is calculated and is compared with the current actual value, and,
d) as a function of the difference between the desired value and the actual value, the actual value is adapted to the desired value.

Alternatively, the invention relates to a method for the controlled admixing of a preadjusted and/or preadjustable quantity (desired value) of a gas or gas mixture to a gas (mixture) flow, wherein
a′) the volume flow rate and/or the pressure of the gas (mixture) flow is determined,
b′) the actual value of the gas or gas mixture to be admixed is compared with the desired value, and,
c′) as a function of the difference between the desired value and the actual value, the actual value is adapted to the desired value.

Methods as well as systems of the above-mentioned type are used, for example, in the mechanical respiration of persons or patients, in the case of spontaneously breathing patients, during anaesthesia as well as in many different respiratory therapies, in which a gas or a gas mixture is supplied to the patent for therapeutic purposes.

The controlled metered addition of NO to a respiratory gas is an example of this type of gas mixture mentioned. Nitric oxide or NO has become known as a drug treating pulmonary hypertension, i.e. a vasodilator. It is an advantage of the treatment by means of the already frequently described NO mixtures that NO is effective only locally, i.e. in the pulmonary circulation, and not systemically. The NO or the NO gas mixture is applied to the patient per inhalations. This means that the therapeutically effective gas is admixed to the respiratory gas supplied to the patient.

When admixing gases or gas mixtures—in the following, now called “gas”—to a gas (mixture) flow—in the following, called “respiratory gas flow”, generally, the concentration of the gas to be added occurring in the respiratory gas flow after the admixing of the gas represents the parameter to be adjusted by the physician. The concentration parameter, should or must be kept constant during the treatment or therapy.

If the volume flow rate of the respiratory gas now changes, a change of the gas flow to be admixed should also take place since otherwise the desired and adjusted concentration in the respiratory gas flow would not remain constant. The quantity or the volume of the gas to be admixed can now be changed either by a variation of the flow rate or the duration of the admixing or metering.

As an alternative to the above-described method of operation, there is a large number of application cases in which a defined dosage of a gas is to be admixed to the respiratory gas flow for the patients. In these cases, the process according to the alternative of the initially mentioned method takes place.

When treating patients, it should also be taken into account that, as a rule, gas is admixed to the respiratory gas flow, if possible, only during the inspiratory phase. In the case of a constant and continuous respiratory gas flow—as a function of the desired or adjusted concentration or dosage—only the flow rate of the gas to be admixed can be varied, because the admixing also has to take place continuously. If a change of the continuous respiratory gas flow takes place,—in order to be able to maintain the adjusted concentration—the flow rate of the gas to be admixed has to be correspondingly increased or decreased.

Thus far, the adaptation of the actual value to the desired value has taken place by varying the flow rate of the gas or gas mixture to be admixed by means of a valve.

It is a disadvantage that admission pressure fluctuations influence the actual flow rate. As a result, during each admission pressure fluctuation, the actual flow rate also has to be changed and therefore has to be readjusted by adjusting the valve.

It is an object of the present invention to provide methods of the initially mentioned type as well as systems of the initially mentioned type for the controlled admixing of at least one gas or gas mixture to a gas (mixture) flow or respiratory gas flow which—independently of the above-mentioned desired application purposes—permits the providing of the gas quantity to be admixed, which is required during a treatment or therapy, at any point in time or the adapting of this gas quantity to the respective prevailing conditions, particularly to the volume flow rate and/or the pressure of the gas (mixture) flow or respiratory gas flow to be supplied to the patient.

With respect to the method, this object is achieved in that the adaptation of the actual value to the desired value takes place by means of a pressure controller influencing the pressure of the gas or gas mixture to be admixed.

The system alternatives according to the invention for the controlled admixing of at least one gas or one gas mixture to a gas (mixture) flow or respiratory gas flow are characterized in that the control device is a pressure controller.

Other objects, advantages and novel features of the present invention will become apparent from the following detailed description of the invention when considered in conjunction with the accompanying drawing.

### BRIEF DESCRIPTION OF THE DRAWING

The sole FIGURE is a schematic view of an embodiment of the system according to the invention by which the alternatives of the method of the invention can be implemented.

### DETAILED DESCRIPTION OF THE INVENTION

The FIGURE shows a first measuring unit 10 which is used for the detection of a volume flow rate and/or of the pressure of the gas (mixture) flow or of the respiratory gas flow which is supplied, for example, to a patient for therapeutic purposes. The FIGURE does not show the conduit by way of which the respiratory gas flow is supplied to the patient.

The measuring unit 10 is connected by way of a data line a with an analyzing unit 20. The measuring unit 10 may be constructed as a flow rate or volume flow rate measuring unit. As an alternative or in addition, it may also be constructed as a pressure sensor which, for example, detects the vacuum which is created during the inspiratory phase.

Furthermore, a measuring unit 40 is provided which is used for the detecting of the volume flow rate and/or of the pressure of the gas or gas mixture, which is to be admixed, in the conduit 1. The measuring unit 40 is also connected by way of a data line 14 with the above-mentioned analyzing unit B.

The gas or gas mixture to be admixed to the respiratory gas flow originates from a correspondingly suitable “gas source” 50, for example, a gas cylinder or gas cartridge, and is admixed by way of the conduits 1, 2, 3 and 4 to the respiratory gas flow to be supplied to the patient.

According to the invention, a pressure controller V is now provided in the conduit 1. This pressure controller V is controlled, for example, by way of an electric servo motor or step motor 30. The electric motor 30 is also connected by way of a data line 12 with the analyzing unit 20.

In the analyzing unit 20, the desired value of the volume flow rate and/or of the pressure of the gas or gas mixture to be admixed is calculated as a function of the volume flow rate and/or pressure of the gas (mixture) flow determined by means of the measuring unit 10, and is compared with the current actual value of the volume flow rate and/or pressure of the gas or gas mixture to be admixed determined by means of the measuring unit 40. As a function of the difference between the desired value and the actual value, an adaptation then takes place of the actual value to the desired value in that, by means of the controller device V, which is assigned to the gas flow or gas mixture flow to be admixed and can be controlled by the analyzing unit 40, the volume flow rate and/or pressure of the gas or gas mixture to be admixed is correspondingly changed.

If—corresponding to another further development of the method of the invention—the pressure controller V is driven by a servo motor or step motor 30 and, by means of the respective position of the servo motor or step motor 30, the preadjusted pressure of the pressure controller V is known, an additional detection of the actual flow rate value and/or actual pressure value of the gas or gas mixture to be admixed will not be necessary, because a conclusion can be drawn from the preadjusted pressure and the known geometry of the pressure controller V with respect to the flow rate of the gas or gas mixture to be admixed.

Furthermore, a valve V1 is provided in the conduit 2, which valve V1 is also in an operative connection with the analyzing unit 20 by way of a data line x or is controlled by the analyzing unit 20. The valve V1 is used for interrupting or (again) releasing at any time the gas flow to be admixed.

In the case of a non-continuous respiratory gas flow, the patient's inspiratory and expiratory phases are detected by means of the measuring unit 10. Corresponding to these phases, the gas flow to be admixed to the respiratory gas flow by way of the conduits 1, 2, 3 and 4 will then be interrupted or released by means of the valve V1. As a function of the respectively desired metering mode, the valve V1 can be released only during the inspiratory phase, only during the expiratory phase or in arbitrary combinations of the above-mentioned operating modes. Thus, by means of the method of the invention, for example, an inspiration-synchronized respiration of a patient can be implemented.

In addition—corresponding to another advantageous further development of the invention—a nozzle E1 connected behind the valve V1 can be provided in the conduit 3. Because of the known geometry of the nozzle E1, the flow rate can be precisely calculated when an admission pressure is known. By way of the conduit 4, the gas to be admixed is supplied to the respiratory gas flow conduit not illustrated in the FIGURE and is then supplied directly to the patient.

As illustrated in the FIGURE, several conduits 2′ and 3′ or 2″ and 3″, which are arranged parallel to the conduits 2 and 3, can also be arranged—behind the measuring unit 40—, these conduits 2′ and 3′ or 2″ and 3″ also each having valves V2 and V3 respectively as well as nozzles E2 and E3 respectively. The controlling of the valves V2 and V3 by the analyzing unit 20 takes place by way of the data lines y and z respectively.

Particularly when nozzles of different nozzles geometries are used, this embodiment of the invention permits the implementation of larger metering ranges. In addition, several of the valves V1, V2 and V3 respectively can be opened isochronously, whereby the volume flows are added up by the individual valves V1, V2 and V3 respectively or conduits 2′ and 3′, or 2″ and 3″ respectively.

In addition, by means of this operating mode, the pressure drop, which necessarily occurs during the opening of a valve V1, V2 and V3 respectively and thus leads to a reduction of the flow rate, can be compensated in that, before the opening of the corresponding valve V1, V2 and V3 respectively, the pressure is increased in order to obtain the desired flow rate in this manner after the opening of the valve V1, V2 and V3 respectively. In order to achieve this, for example, also the opening time of the valve V1, V2 and V3 respectively can be lengthened correspondingly.

As initially mentioned, the method alternatives as well as system alternatives according to the invention are suitable for the mechanical respiration of patients, for spontaneously breathing patients, for anaesthesia as well as for many different respiratory therapies, in which a gas or a gas mixture is supplied to the patent for therapeutic purposes.

Besides the also above-mentioned metered addition of NO to the respiratory gas,—NO acting as a medication against pulmonary hypertension—, the gas or gas mixture to be admixed may be air, perfluorocarbon, O₂, Xe, an Xe mixture, an NO mixture, CO, a CO mixture, a CO₂ mixture for respiratory stimulation, an H₂ mixture, N₂O, an N₂O mixture, an SF_{6?} mixture, nitroso ethanol or an anaesthetic gas. The gas (mixture) flow or respiratory gas flow to be supplied to the patient preferably is air, O₂, N₂, Ar, Xe, He, SF_{6?} and/or an anaesthetic gas, a mixture of these gases or another therapeutically effective or therapeutically ineffective gas or gas mixture.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for the controlled admixing of at least one gas or a gas mixture to a gas flow, so that, after the admixing to the gas flow, the gas or gas mixture has a preadjusted and/or preadjustable concentration in said gas flow, said method comprising the steps:
a) determining at least one of a volume flow rate and pressure of the gas flow,
b) determining an actual value of at least one of a volume flow rate and pressure of the at least one gas or gas mixture to be admixed;
c) calculating, as a function of the determined at least one volume flow rate and pressure of the gas flow, a desired value of at least one of the volume flow rate and the pressure of the at least one gas or gas mixture to be admixed;
d) comparing the desired value with the determined actual value; and
e) modify the actual value to the desired value as a function of the difference between the desired value and the actual value, by influencing a pressure of the at least one gas or gas mixture to be admixed with a pressure controller.

2. A method for the controlled admixing of a preadjusted or preadjustable quantity of a gas or gas mixture to a gas flow, said method comprising the steps:
a′) comparing an actual value of the gas or gas mixture to be admixed with a desired value, and
b′) modifying the actual value to the desired value as a function of the difference between the desired value and the actual value, wherein the step of modifying includes the step of influencing the pressure of the gas or gas mixture to be admixed with a pressure controller.

3. The method according to claim 2, further including the step of determining one of a volume flow rate and pressure of the gas flow.

4. The method according to claim 1, wherein the pressure controller is driven by one of a servo motor or a step motor.

5. The method according to claim 1, including the step of driving the pressure controller by a servo motor or a step motor, and by means of the position of the servo motor or step motor, the preadjusted pressure of the pressure controller being known, thereby eliminating a requirement for an additional detection of the actual flow rate value and/or the actual pressure value of the gas or gas mixture to be admixed.

6. The method according to claim 1, including the step of temporarily interrupting the admixing of the gas or gas mixture to the gas flow.

7. The method according to claim 1, wherein the gas or gas mixture being admixed to a gas flow is supplied to a person, wherein at least during the person's expiratory phase, the admixing of the gas or gas mixture is interrupted.

8. The method according to claim 1, wherein the gas flow or gas mixture flow to be admixed is divided into several partial flows whose flow rates are controlled.

9. The method according to claim 1, wherein the gas or gas mixture to be admixed is at least one of air, perfluorocarbon, O₂, Xe, an Xe mixture, NO, an NO mixture, CO, a CO mixture, a CO₂ mixture for respiratory stimulation, an H₂ mixture, N₂O, an N₂O mixture, an 8F₆ mixture, nitroso ethanol or an anaesthetic gas.

10. The method according to claim 1, wherein the gas flow is at least one of air, O₂, N₂, Ar, Xe, He, SF_{6?} and/or an anaesthetic gas, a mixture of these gases or another therapeutically effective or therapeutically ineffective gas or gas mixture.

11. A system for the controlled admixing of at least one gas or a gas mixture to a gas flow, whereby, after the admixing to the gas flow, the gas or gas mixture has at least one of a preadjusted and preadjustable concentration in said gas flow, said system comprising:
a) a first measuring unit for detecting at least one of a volume flow rate and pressure of the gas flow,
b) a second measuring unit for detecting an actual value of at least one of a volume flow rate and pressure of the gas or gas mixture to be admixed,
c) an analyzing unit in which, as a function of the least one of a determined volume flow rate and pressure of the gas flow, the desired value of the at least one volume flow rate and the pressure of the gas or gas mixture to be admixed is calculated and is compared with the measured actual value, and
d) a pressure controller associated with the gas or gas mixture flow to be admixed and which is controlled by the analyzing unit, so that the actual value is adapted to the desired value as a function of the difference between the desired value and the actual value.

12. A system for the controlled admixing of a preadjusted quantity of a gas or gas mixture to a gas flow, said system comprising
a′) a measuring unit for detecting an actual value of the volume flow rate of the gas or gas mixture to be admixed,
b′) an analyzing unit for comparing said detected actual value with a desired value, and
d) a pressure controller associated with the gas or gas mixture flow to be admixed and controlled by the analyzing unit so that the actual value is adapted to the desired value as a function of the difference between the desired value and the actual value.

13. The system according to claim 12, further including an additional measuring unit for the detecting at least one of a volume flow rate and pressure of the gas flow.

14. The system according to claim 11, further including at least one valve connected to the pressure controller.

15. The system according to claim 11, further including at least one nozzle connected to the pressure controller.

16. The system according to claim 11, wherein the pressure controller is driven by one of a servo motor and a step motor.

17. The method according to claim 2, wherein the pressure controller is driven by one of a servo motor or a step motor.

18. The method according to claim 2, including the step of driving the pressure controller by a servo motor or a step motor, and by means of the position of the servo motor or step motor, the preadjusted pressure of the pressure controller being known, thereby eliminating a requirement for an additional detection of the actual flow rate value and/or the actual pressure value of the gas or gas mixture to be admixed.

19. A control system for controlling of a gas to a gas flow, comprising:
a measuring device for measuring a volume flow rate of the gas to be admixed;
a comparing device for comparing said measured volume flow rate with a desired volume rate of the gas; and
a pressure controller for controlling the volume flow rate of the gas to the admixed as a function of an output of said comparing device.

20. The control system according to claim 19, further including an additional measuring device for measuring the volume flow rate of the gas flow; and
a calculating device for calculating the desired rate as a function of the measured volume flow rate of the gas flow.
